(19) United States
(12) Patent Application Publication
(10) Pub. No.: US 2026/0097564 A1
(43) Pub. Date: Apr. 9, 2026

(54) SYSTEM AND METHODS FOR FAST ERROR DETECTION AND RENDERING FOR ADDITIVE MANUFACTURING USING STRUCTURED LIGHT

(71) Applicant: Purdue Research Foundation, West Lafayette, IN (US)

(72) Inventors: Song Zhang, West Lafayette, IN (US); Jack M. Girard, Lakewood, CO (US)

(73) Assignee: Purdue Research Foundation, West Lafayette, IN (US)

(21) Appl. No.: 19/349,379

(22) Filed: Oct. 3, 2025

Related U.S. Application Data
(60) Provisional application No. 63/702,956, filed on Oct. 3, 2024.

(51) Int. Cl. B29C 64/393; B29C 64/10; B29C 64/20; B33Y 10/00; B33Y 30/00; B33Y 50/02

(52) U.S. Cl. CPC B29C 64/393; B29C 64/10; B29C 64/20; B33Y 10/00; B33Y 30/00; B33Y 50/02

(57) ABSTRACT

A projector may project a fringe pattern onto a deposited layer from an additive manufacturing printer. A camera may capture set of fringe images of the deposited layer. Then, a system may compute a two-dimensional absolute phase map that encodes surface height information of the deposited layer. The system may generate a threshold phase map corresponding to an intended geometry of the deposited layer. The system may compare the absolute phase map to the threshold phase map on a pixel-by-pixel basis to detect error regions in the deposited layer. The comparison may be performed in the two-dimensional phase domain without reconstructing a complete three-dimensional point cloud. The system may selectively reconstruct three-dimensional data only for pixels corresponding to the detected regions, thereby reducing computational resources required for in-situ process monitoring.

### CROSS REFERENCE TO RELATED APPLICATIONS

This application claims the benefit of U.S. Provisional Application No. 63/702,956 filed Oct. 3, 2024, the entirety of which is hereby incorporated by reference.

### GOVERNMENT RIGHTS

This invention was made with government support under W911 NF-20-2-0189 awarded by the Army Research Office. The government has certain rights in the invention.

### TECHNICAL FIELD

This disclosure relates to additive manufacturing and, in particular, to error detection and correcting in additive manufacturing

### BACKGROUND

Additive manufacturing (AM) is a technology capable of producing complex, personalized parts in a flexible and cost-effective way compared to conventional manufacturing. Its capabilities extend to a wide range of application areas, including biomedicine, engineering, architecture, textiles, and other industries. To complement its various application areas, AM also supports an extensive selection of materials, such as polymers, metals, ceramics, and composites. From an economic point of view, AM is preferable to conventional manufacturing in scenarios that require some combination of low-volume production, high-complexity part geometries, and highly customized designs.

Defect monitoring and visualization in AM helps reduce the time and material costs associated with part rejection by detecting and addressing errors during production. It also allows users to verify whether their part meets design requirements as it is being constructed, thus increasing overall user confidence in the final product.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The embodiments may be better understood with reference to the following drawings and description. The components in the figures are not necessarily to scale. Moreover, in the figures, like-referenced numerals designate corresponding parts throughout the different views.

FIG. 1 illustrates a first example of a system.

FIG. 2 illustrates a flow diagram for logic of a system

FIG. 3 illustrates an example of structured light (SL) system.

FIG. 4 illustrates an example of a 3D reconstruction procedure using shape measurement from raw fringe image data.

FIG. 5 illustrates a visual example of a threshold phase generation.

FIG. 6. Illustrates an example of a threshold phase map.

FIG. 7A-D illustrates an example error mask and geometry mask and their relation to the ideal and deposited geometries.

FIG. 8 illustrates a second example of a system.

### DETAILED DESCRIPTION

Defect monitoring in additive manufacturing (AM) has been achieved using two-dimensional (2D) imaging techniques. Specific methods include texture-based image analysis, computer vision, thermal imaging, and analysis of tomography image data. The general purposes of using such methods include defect identification, defect classification, or geometric part measurement, depending on the particular sensor instrumentation and application. Digital image correlation has been used to characterize defects, evaluate residual stresses, and quantify geometric distortions. Digital twin technology has also been developed and tested, leveraging the fusion of camera and other sensor data to assess quality within an AM process. Additionally, dark field observation has been applied to estimate the densification of the deposited material.

While there is substantial research supporting the success of 2D imaging solutions for process monitoring in additive manufacturing, a limitation is that 2D imaging often does not provide access to three-dimensional (3D) information about the as-built surface geometry. Spatial depth information, which enables a more accurate representation of surface topology, remains inaccessible or must be inferred from image features. This limitation poses a challenge, as additive manufacturing process investigation methods—such as root cause analysis or quality assurance—would significantly benefit from additional 3D information to support more informed decision-making.

Process monitoring in AM has also been achieved using 3D imaging techniques. Reconstruction of sensor measurements into 3D point cloud data is well documented. Methods include structured light imaging, laser scanning, and optical coherence tomography. The optimal method for a given application may depend on factors such as user preference, AM hardware, build material, the specific error types being monitored, or available budget.

Multiple existing process monitoring solutions are based on global 3D reconstruction. There is a motivated opportunity to explore alternative options, as the problem of time-consuming 3D reconstruction of large data sets has previously been mentioned. Frequently, additional point cloud processing is carried out on the raw reconstructed point cloud before further data analysis begins. Post-processing procedures include noise reduction, region segmentation, or region partitioning for reasons such as feature extraction, feature classification, or region isolation. Others have implemented point cloud down sampling to help compensate for computational time. In some situations, only a fraction of the reconstructed point cloud is relevant for downstream process monitoring routines. The remainder of the data in the point cloud may represent the un-used build surface with the sensor's field of view (FOV). The combination of global 3D reconstruction followed by point cloud processing illustrates a scenario where time efficiency could be further improved in various existing 3D imaging solutions for AM process monitoring. 3D imaging techniques have been used in unique ways to successfully monitor AM processes. One such approach generates a 3D point cloud that is rasterized into an image for defect identification. Another method involves the reconstruction of side surfaces using multilayer contour stacking. Some systems have integrated 2D thermal imaging with 3D laser scanning to control when deposition of the following layer begins. Additionally, side-scattered light through translucent polymers has been measured to generate 3D volumetric point cloud data on the fly.

The research and application of machine learning (ML) in additive manufacturing for process monitoring is well studied and has been summarized previously. Many ML-based solutions use 2D images as input for the ML model, and others use 3D point cloud data as input for the ML model. Another solution uses environmental sensor parameters as input to the ML model. Others have investigated the conversion of reconstructed 3D point cloud data into 2D images that are then used as input to the ML model. ML has also been used to predict the surface roughness of the deposited material. One major benefit of ML solutions is that they allow closed-loop process control through informed decision making in the form of actions such as stopping the operation, adjusting the operation parameters, or manipulating the G-code. This prevents errors from propagating to the following layers in the AM process, minimizing the amount of time spent applying corrective action.

ML solutions often require preprocessing of raw data before it can be fed into the model. Generally, ML solutions require extensive data sets for model training and validation. Unless the end user of an AM machine has sacrificed time or money to obtain a trained ML model, ML solutions are less capable of plug-and-play operation compared to standalone 2D or 3D imaging methods once the AM hardware and imaging sensor subsystem(s) are configured. Based on existing process monitoring solutions, it is very challenging for any approach to analyze full-resolution sensor data for real-time closed-loop AM process monitoring applications.

In certain embodiments, the system and methods described herein provide a real-time additive manufacturing process monitoring method for closed-loop applications. The approach utilizes a unique characteristic of structured light 3D imaging technology, which enables direct pixel-by-pixel correspondence between the captured two-dimensional images and the reconstructed 3D point cloud. Instead of analyzing the reconstructed 3D point cloud for error detection, our proposed error detection method is performed in the 2D phase domain prior to 3D reconstruction to speed up the entire process. We develop a computational framework that allows pixel-by-pixel comparison between the actual deposited layer geometry and the desired layer geometry to identify error regions. The error regions in each layer, represented as a binary mask image, may be used to reconstruct only the erroneous pixels from the SL system for further analysis. Since this proposed method minimizes 3D reconstruction and analysis for AM error detection, it can dramatically reduce the complexity and computational time that is critical for efficient in-situ AM process monitoring.

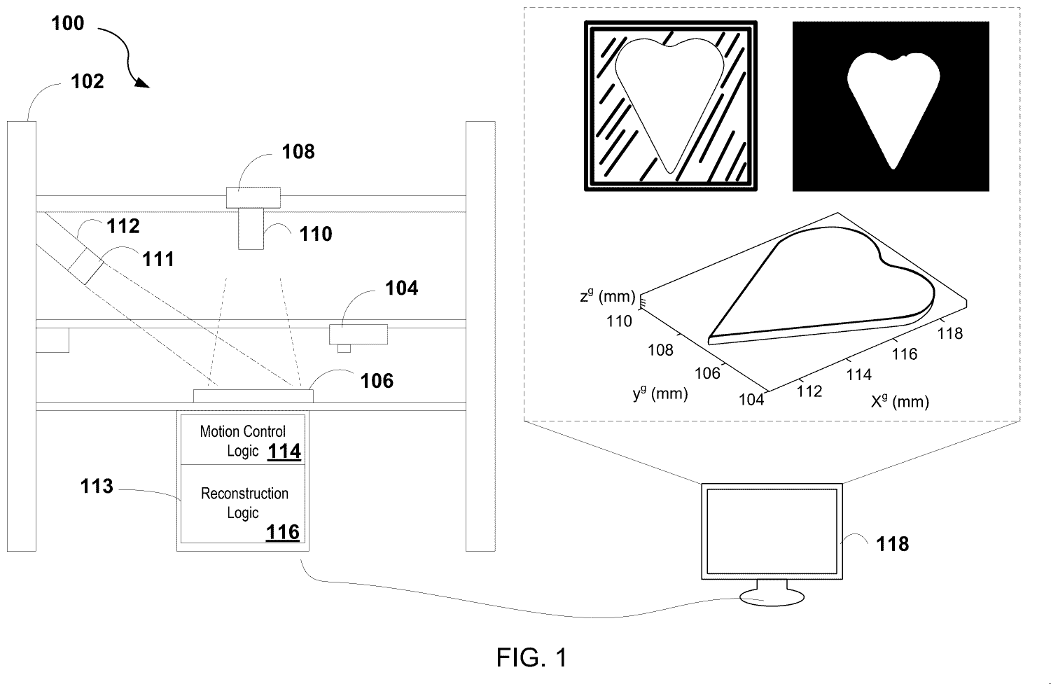

FIG. 1 illustrates a first example of a system 100. The system 100 may include an additive manufacturing (AM) machine 102. The additive manufacturing machine 102 may fabricate three-dimensional objects through a layer-by-layer deposition process. The AM machine 102 may comprise a material extruder (104), such as a filament extruder, which deposits build material—typically thermoplastic filament—along programmed toolpaths to form successive layers of a work piece 106. The first layer of the work piece may be deposited onto a build surface where succussive layers may be deposited onto a build layer of the work piece 106.

The work piece 106 refers to the in-progress object being manufactured, which evolves incrementally as each layer is deposited. The extruder 104 may be controlled by instructions, such as G-Code, that define the spatial geometry and deposition parameters for each layer. The system 100 may further include motion control logic for precise positioning of the extrusion head. The motion control logic may control various actuators, drives, servos and other actuators which move the extruder, the build plate, and other parts of the AM machine to facilitate printing.

The system 100 may include a camera 108. The camera may include, for example, a charge-coupled device (CCD), or some other of electronic imaging sensor used in cameras to convert light into electrical signals. The sensor may include, for example, array of photosensitive elements that accumulate charge proportional to the intensity of incident light. These charges are transferred across the chip and read out sequentially to form a digital image. During operation of the AM machine 102, the sensor captures fringe pattern images projected onto the surface of a printed object. These images are used to compute phase maps and reconstruct three-dimensional surface geometry for error detection and process monitoring. CCD sensors in particular are known for their high image quality, low noise, and precise spatial resolution, making them suitable for metrology-grade applications.

The camera 108 may be equipped with a telecentric lens 110 which enables orthographic projection and ensures consistent magnification across the field of view, regardless of depth variations. This configuration allows for high-precision acquisition of surface geometry data by minimizing distortion and depth sensitivity along the optical axis.

The camera 108 may operate at full resolution (e.g., 1920×1200 pixels) and be synchronized with a structured light projector to capture a sequence of phase-shifted fringe images. These images are processed to generate wrapped and unwrapped phase maps, which encode height information at each pixel. The camera 108 may be calibrated using a structured light system calibration procedure to establish its intrinsic and extrinsic parameters, enabling accurate mapping of image coordinates to world coordinates. During operation, the camera may be triggered to capture images at precise moments in the printing cycle, ensuring alignment with the additive manufacturing machine's movements and facilitating real-time error detection.

The system 100 may include a projector 112. The project 112 may include a digital micromirror device (DMD). The DMD may include array of microscopic mirrors that can be individually tilted to modulate light intensity and direction. The projector 112 may display structured light fringe patterns onto the surface of the work piece 106 during an additive manufacturing process. The projector 112 may utilize a digital light processing (DLP) engine, such as the Texas Instruments Pro 4500, equipped with a lens 111. The lens may include, for example, a pinhole lens having a focal length of, for example, approximately 92 mm, though other lengths are possible. The projector 112 may project multi-frequency fringe patterns with precise phase shifts. These patterns are used to encode surface geometry information into the captured images. The projector 112 may follow, for example, a standard pinhole projection model, which enables accurate mapping of projected image coordinates to the world coordinate system. Calibration of the projector 112 is performed using a structured light system calibration procedure, which determines its intrinsic matrix, rotation, and translation parameters relative to the camera and the additive manufacturing machine. During operation, the projector 112 continuously projects fringe patterns while the camera captures synchronized images, allowing for phase shifting and unwrapping to generate absolute phase maps. These maps are used for pixel-wise comparison against threshold phase maps to detect geometric errors in the printed layer. The projector 112 is physically integrated with the camera on a custom gantry system, ensuring stable alignment and consistent projection across the build surface.

The system 100 may include a control board 113. The control board, which is typically attached to the AM machine 113, may include the one or more processor(s) and drivers which operate the AM machine. For example, the control board 113 may include and/or execute motion control logic 114. The motion control logic 114 may govern the precise execution of material deposition through coordinated interpretation and transformation of G-code instructions. The motion control logic 114 may engage various actuators, motors, and the like to move the extruder 104 along various tool paths, extruding material along the way to build work piece layer by layer.

The system 100 may include reconstruction logic 116 which coordinates operation of the camera, the projector, detecting errors in the build, generating three dimensional data representative of errors, causing the three-dimensional data to be rendered and displayed, and other operations described herein. The reconstruction logic 116 in FIG. 1 is shown as included in control board 113 of the AM machine 102. It should be appreciated that the reconstruction logic 116 could reside, partially or completely, in other computing devices, servers, or the like which are local or remote to the AM machine 102.

The system may include a display 118. The display 118 may show visual representations of the three-dimensional data corresponding to the errors or error regions detected by the reconstruction logic 116. In some examples, the reconstruction logic 116 may cause display 118 to show the three-dimensional data on the display. In other examples, the reconstruction logic 116 may generate output information that is stored and/or communicated to other systems which displays the output information.

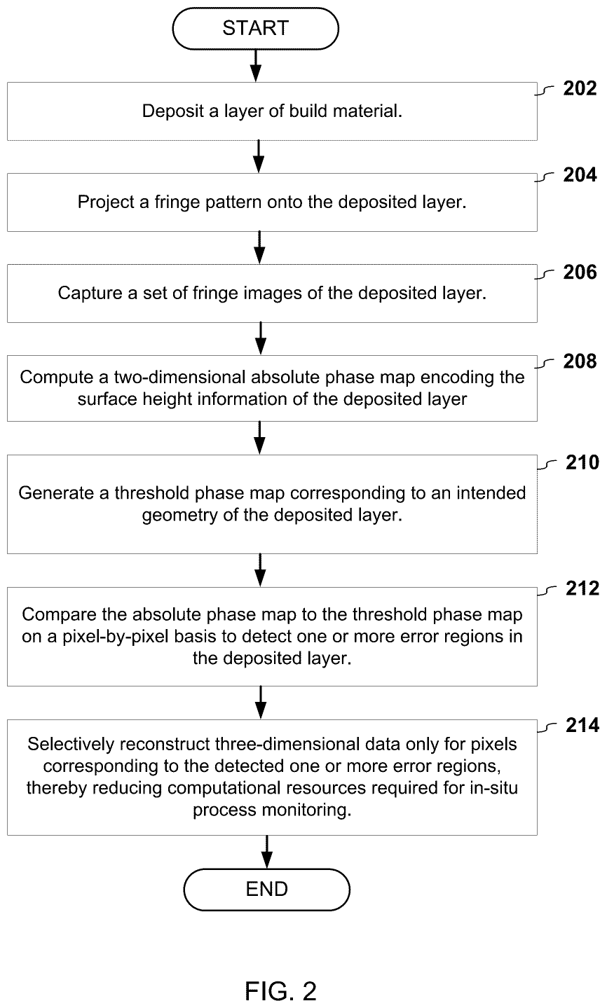

FIG. 2 illustrates a flow diagram for logic of the system 100. The motion control logic 114 may deposit a layer of build material onto a build layer a build surface (202). The build layer refers to the most recent printed layer of a work piece. The build surface refers to the surface of a build plate for the AM machine 102.

The reconstruction logic 116 may cause the projector 112 to project a fringe pattern onto the deposited layer (204). The camera 108 may be optically aligned with the projector 112 and capture a set of fringe images of the deposited layer (206). The reconstruction logic 116 may compute, using the set of fringe images, a two-dimensional absolute phase map (208). The absolute phase map may encode the surface height information of the deposited layer.

An absolute phase map in the context of structured light 3D imaging for additive manufacturing (AM) is a two-dimensional representation that encodes the height information of a surface based on the phase of projected fringe patterns. It is derived from a sequence of wrapped phase maps that are processed using phase unwrapping algorithms to remove discontinuities and yield a continuous phase distribution across the image.

This map is directly related to the projector's image coordinate system and provides a pixel-by-pixel correspondence between the measured surface and its spatial geometry. The absolute phase increases across the image from a defined edge and serves as a computationally efficient alternative to full 3D reconstruction. Because the mapping from absolute phase to 3D Cartesian coordinates is one-to-one, the spatial information needed for reconstruction is embedded in the phase domain.

The monitoring logic may generate a threshold phase map corresponding to an intended geometry of the deposited layer (210). A threshold phase map is a pixel-wise representation of the ideal material deposition geometry encoded in the absolute phase domain. Generally, the threshold phase map is assigned with the camera image coordinate system. It may be generated from build instructions (i.e. G-Code) corresponding to each layer of an additive manufacturing (AM) process and serves as a reference against which measured phase data can be compared for error detection. The threshold phase map is constructed, in some examples, by re-sampling deposition path data, generating boundary points around each movement based on nozzle diameter and deposition settings, and applying barycentric interpolation across triangular partitions of the image coordinate system. Each pixel's phase value in the map is computed as a weighted sum of the absolute phase values at the triangle's vertices. The resulting map is continuous and bounded within the geometric cross-section of the intended print layer. It enables efficient image-based comparison with measured absolute phase maps to identify deviations such as under-deposition or over-deposition, thereby facilitating real-time, in-situ error detection without requiring full 3D reconstruction.

The reconstruction logic 116 may compare the absolute phase map to the threshold phase map on a pixel-by-pixel basis to detect one or more error regions in the deposited layer (212). To detect geometric errors in a deposited layer during an additive manufacturing process, the system performs a pixel-by-pixel comparison between a measured absolute phase map and the threshold phase map. Both maps reside in the absolute phase domain and may be aligned to the camera image coordinate system. The threshold phase map encodes the ideal deposition geometry derived from G-code instructions, while the absolute phase map captures the actual surface topology using structured light imaging. For each pixel, the system evaluates the phase difference between the measured and ideal values. If the absolute phase value exceeds the threshold phase value, an under-deposition or missing geometry error is flagged; conversely, if the absolute phase value falls below the threshold, an over-deposition error is indicated. This comparison yields a binary error mask that identifies regions of deviation from the intended geometry. The process avoids full 3D reconstruction, enabling efficient, real-time error detection using image-based processing technique.

The reconstruction logic 116 may selectively reconstruct three-dimensional data only for pixels corresponding to the detected one or more error regions, thereby reducing computational resources required for in-situ process monitoring (214). Upon identification of one or more error regions through pixel-wise comparison between the measured absolute phase map and the threshold phase map, the system may selectively reconstruct three-dimensional data only for those pixels flagged as erroneous. This is achieved by applying, for example, the stereo 3D reconstruction algorithm exclusively to image coordinates where the error mask indicates a deviation from the intended geometry. By limiting the reconstruction to a subset of pixels, the system avoids the computational burden associated with global 3D reconstruction of the entire image array. The reconstructed data points are then transformed into the additive manufacturing coordinate system, or other coordinate systems, for further analysis. This targeted reconstruction approach significantly reduces processing time and resource consumption, enabling efficient in-situ monitoring and facilitating real-time decision-making for corrective actions such as print continuation, termination, or error correction

As used herein, a “region” refers to a spatially defined subset of pixels that collectively exhibit a deviation from the expected deposition geometry during an additive manufacturing process. A region may include one or more contiguous or non-contiguous pixel clusters identified through pixel-wise comparison between a measured absolute phase map and a threshold phase map. Each pixel within a region satisfies a predefined phase difference condition indicating either under-deposition or over-deposition. Regions may vary in shape, size, and distribution, and are not limited to connected pixel groups; multiple isolated shapes may constitute distinct regions. These regions are used to selectively reconstruct three-dimensional data for error analysis and corrective action, thereby optimizing computational efficiency in in-situ process monitoring.

The reconstruction logic 116 may prepare and/or render selectively reconstructed three-dimensional data corresponding to one or more detected error regions in various coordinate domains depending on the intended visualization or analysis. In one embodiment, the data may be rendered directly onto the camera image coordinate system, enabling overlay visualization of error regions on the captured structured light image for intuitive in-situ monitoring. In another embodiment, the reconstructed data may be transformed and rendered onto the digital model of the part being printed, such as within the G-code coordinate system, allowing correlation of error regions with specific toolpaths or design features. Additionally, the data may be mapped to the world or projector coordinate system to support precise spatial analysis or integration with external metrology systems. These rendering options facilitate flexible visualization and efficient decision-making during additive manufacturing processes.

In some examples the reconstruction logic 116 may cause printing to pause or stop in response to the detected error regions exceed a predefined threshold size or number. For example, amount of under extrusion, over extrusion, and/or other measurable defects may exceed a predefined metric. The reconstruction logic 116 may cause the AM machine 102 to stop or pause printing. Alternatively or in addition, the reconstruction logic 116 may track the number of defects and when the number exceeds a threshold number, the reconstruction logic 116 may cause the AM machine 102 to stop or pause printing.

The system and methods described herein may be implemented in many ways. The logic described herein may include additional, fewer, or other steps than those described above. Additional examples, embodiments, and explanation follow.

### Phase Shifting and Phase Unwrapping Algorithms

The system and methods described herein may employ an N-step least-squared phase shifting algorithm to calculate the wrapped phase for each fringe period. The intensity of the n-th projected fringe image is mathematically expressed as follows:

$${I}_{n} ( i , j ) = {I}^{′} ( i , j ) + {I}^{″} ( i , j ) cos ( ϕ ( i , j ) + {δ}_{n} ) \qquad Eq . 1$$

where (i, j) is a camera pixel coordinate, Iₙ represents the total intensity, I′ represents the average intensity, I″ represents the modulation of intensity, φ is the wrapped phase to be solved for, and δₙ is the phase shift. By simultaneously solving the N equations using least-squares, the phase can be determined using

$$ϕ ( i , j ) = - {tan}^{- 1} [ \frac{{\sum }_{n = 1}^{N} {I}_{n} sin {δ}_{n}}{{\sum }_{n = 1}^{N} \vert {I}_{n} cos {δ}_{n}} ] \qquad Eq . 2$$

where φ(i, j)∈[π,−π]. To remove the 2π discontinuities, a phase unwrapping algorithm that has been developed in the past can be used to recover the unwrapped phase map. Using such an algorithm, the expression for the unwrapped phase map is mathematically represented as

$$Φ ( i , j ) = ϕ ( i , j ) + 2 π \times κ ( i , j ) \qquad Eq . 3$$

where Φ is the unwrapped phase map, φ is the wrapped phase map, and κ(i, j) is an integer number obtained from the phase unwrapping algorithm.

### Coordinate System Definitions

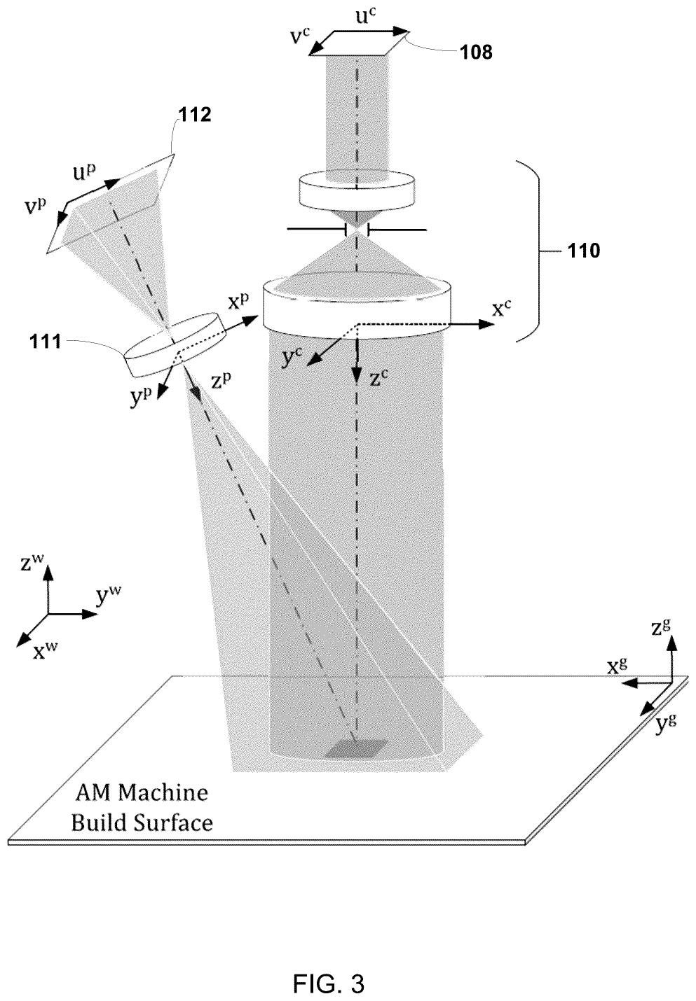

FIG. 3 illustrates an example of structured light (SL) system for 3D shape measurement and AM machine build surface, with labeled coordinate systems. The SL system may be a subsystem of the system 100 shown in FIG. 1, and include the camera 108, the camera lens 110, projector 112, and the projector lens 111.

The The superscript ‘c’ denotes camera-related coordinate systems, the superscript ‘p’ denotes projector-related coordinate systems, the superscript ‘w’ denotes the world coordinate system, and the superscript ‘g’ denotes the G-code coordinate system. In this configuration, a telecentric lens is used for the camera and a pinhole lens is used for the projector.

The camera lens follows an orthographic projection model and produces a linear magnification along the x^{c}- and y^{c}-axes, while it is not sensitive to depth variation along the z^{c}-axis. The governing equation for the orthographic projection model may be mathematically represented as

$${[ {u}^{c} , {v}^{c} , 1 ]}^{T} = {{M}_{c} [ {x}^{w} , {y}^{w} , {𝓏}^{w} , 1 ]}^{T} \qquad Eq . 4$$

where (u^{c}, v^{c}) is a camera pixel coordinate, T denotes the matrix transpose operator, (x^{w}, y^{w}, z^{w}) is a point in the world 3D Cartesian coordinate system, and M^{c} is the camera matrix defined as the multiplication of a 3×4 ray transfer matrix and a 4×4 matrix that combines rotation and translation. The projector lens follows a standard pinhole model. The governing equation for this model, without accounting for distortion, may be mathematically represented as

$${[ {u}^{p} , {v}^{p} , 1 ]}^{T} = {{A}_{p} [ {R}^{p} , {\vec{t}}^{p} ] [ {x}^{w} , {y}^{w} , {𝓏}^{w} , 1 ]}^{T} \qquad Eq . 5$$

where s is a scaling factor, (u^{p}, v^{p}) is a projector pixel coordinate, T denotes the matrix transpose operator, Ap is the 3×3 projector intrinsic matrix, [R^{p},t^{p}] are the rotation and translation parameters from (x^{w}, y^{w}, z^{w}) to (x^{p}, y^{p}, z^{p}), which is a point in the 3D Cartesian coordinate system of the projector. Parameters M^{c}, A^{p}, R^{p}, and t^{p} can be calculated using an SL system calibration procedure. This research uses an established calibration method for an SL system with a telecentric camera lens. The resulting camera calibration matrix H^{c} and projector calibration matrix H^{p} can be mathematically written as

$${H}^{c} = {M}^{c} \qquad Eq . 6$$

$${H}^{p} = {A}^{p} [ {R}^{p} , {\vec{t}}^{p} ] \qquad Eq . 7$$

During single-telecentric SL system calibration, the world coordinates are aligned with the projector coordinates. This is done to maximize the accuracy of the calibration and avoid the need to estimate the absolute extrinsic parameters for both the camera and the projector [93]. Therefore, the following equations become true

$$[ {R}^{p} , {\vec{t}}^{p} ] = [ \begin{matrix}1 & 0 & 0 & 0 \\ 0 & 1 & 0 & 0 \\ 0 & 0 & 1 & 0\end{matrix} ] \qquad Eq . 8$$

$${X}^{w} = {[ {x}^{w} , {y}^{w} , {𝓏}^{w} ]}^{T} = {[ {x}^{p} , {y}^{p} , {𝓏}^{p} ]}^{T} , = {X}^{p} \qquad Eq . 9$$

where X^{w} and X^{p} are shorthand representations for the 3D Cartesian coordinate systems of the world and the projector, respectively.

The G-code coordinate system, X^{g}, is a virtual 3D Cartesian coordinate system. An AM machine references X^{g} when executing G-code movement commands. When X^{g} is referenced, its observed location and orientation can vary between particular AM instances and machines, since the execution of G-code commands is mechanically coupled to an AM machine and its components that have fixed degrees of freedom.

This research also uses a multi-system transformation matrix to align X^{w} with X^{g}. Let M^{MS}=[R^{MS}, t^{MS}] represent the 3×4 multi-system transform matrix from X^{w} to X^{g} within the camera FOV. As a result of Eq. (8)-(9), M^{MS} becomes the rigid transform from X^{p} to X^{g}, which can be mathematically represented as

$${[ {x}^{g} , {y}^{g} , {𝓏}^{g} ]}^{T} = {{M}^{MS} [ {x}^{p} , {y}^{p} , {𝓏}^{p} , 1 ]}^{T} \qquad Eq . 10$$

where (x^{g}, y^{g}, z^{g}) is a point in X^{g}. MMS must be calculated using a separate multi-system calibration procedure that involves both the SL system and the AM machine. A basic geometric shape with a known location in X^{g} is deposited, measured, and reconstructed into X^{w} coordinates. A rigid transformation between X^{w} and X^{g} is then computed using a point cloud centroid calculation and singular value decomposition (SVD).

### 3D Shape Measurement

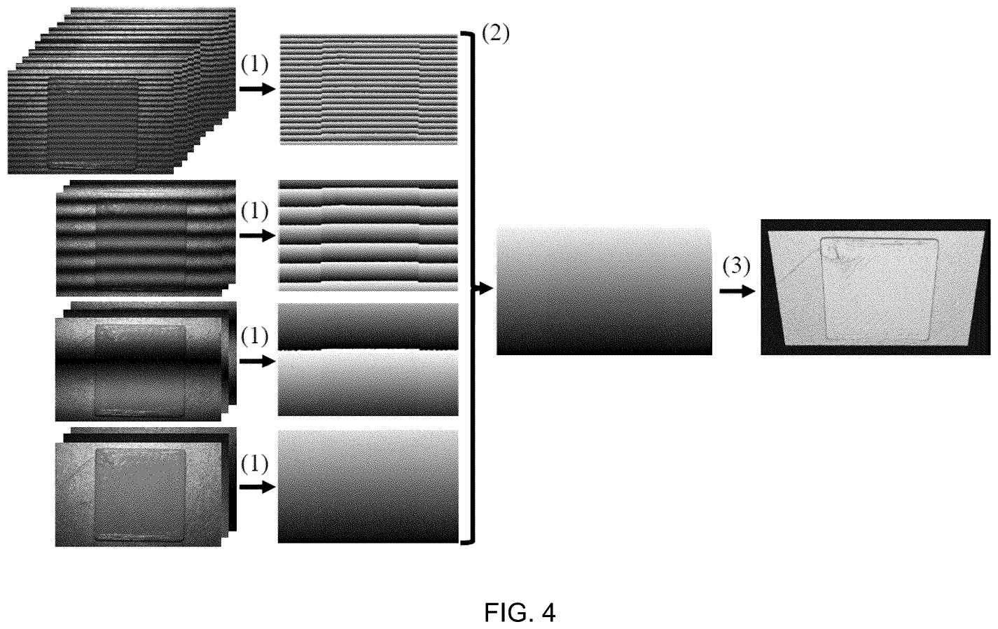

FIG. 4 illustrates an example of a 3D reconstruction procedure using shape measurement from raw fringe image data. A sequence of captured fringe images is systematically processed and reconstructed to generate a single point cloud for each measurement. For each fringe frequency, a wrapped phase map is calculated according to Eq. 1-2 (1). A series of phase unwrapping is performed using each of the wrapped phase maps and Eq. 3 repetitively to obtain the absolute phase map (2). Once the absolute phase map is obtained, the measured surface is reconstructed into X^{w} coordinates (3). Some embodiments may use a stereo 3D reconstruction method, and its governing equation can be mathematically represented as

$$[ \begin{matrix}{x}^{w} \\ {y}^{w} \\ {z}^{w}\end{matrix} ] = [ \begin{matrix}{h}_{11}^{c} - {u}^{c} {h}_{31}^{c} & {h}_{12}^{c} - {u}^{c} {h}_{32}^{c} & {h}_{13}^{c} - {u}^{c} {h}_{33}^{c} \\ {h}_{21}^{c} - {u}^{c} {h}_{31}^{c} & {h}_{22}^{c} - {u}^{c} {h}_{32}^{c} & {h}_{22}^{c} - {u}^{c} {h}_{33}^{c} \\ {h}_{31}^{c} - {u}^{c} {h}_{31}^{c} & {h}_{32}^{c} - {u}^{c} {h}_{32}^{c} & {h}_{33}^{c} - {u}^{c} {h}_{33}^{c}\end{matrix} ] \qquad Eq . 11$$

where h^{c}ᵢⱼ and h^{p}ᵢⱼ are elements of H_{c} and Hₚ, respectively. It is also known that the absolute phase is related to the projector image coordinate system according to the following mathematical relationship

$${u}^{p} = {Φ}_{a} \cdot \frac{{P}_{u}}{2 π} \qquad Eq . 12$$

where Φₐ is the absolute phase and Pu is the smallest fringe period in the u^{p}-direction. It is assumed that the absolute phase starts from the edge and increases across the image.

As shown in Eq. (11)-(12), the mapping from Φₐ to (x^{w}, y^{w}, z^{w}) is one-to-one and pixel-by-pixel. Therefore, all the information contained in the reconstructed (x^{w}, y^{w}, z^{w}) data points is encoded in the absolute phase domain. Further, Eq. (11) includes a matrix inverse operator, which means that the 3D reconstruction from Φ^{a} to (x^{w}, y^{w}, z^{w}) is computationally expensive for large image arrays. This is the central motivation to utilize the absolute phase domain for spatial error detection. It requires less computation to reach, but stores the same information that the 3D Cartesian domain does.

### Threshold Phase Generation

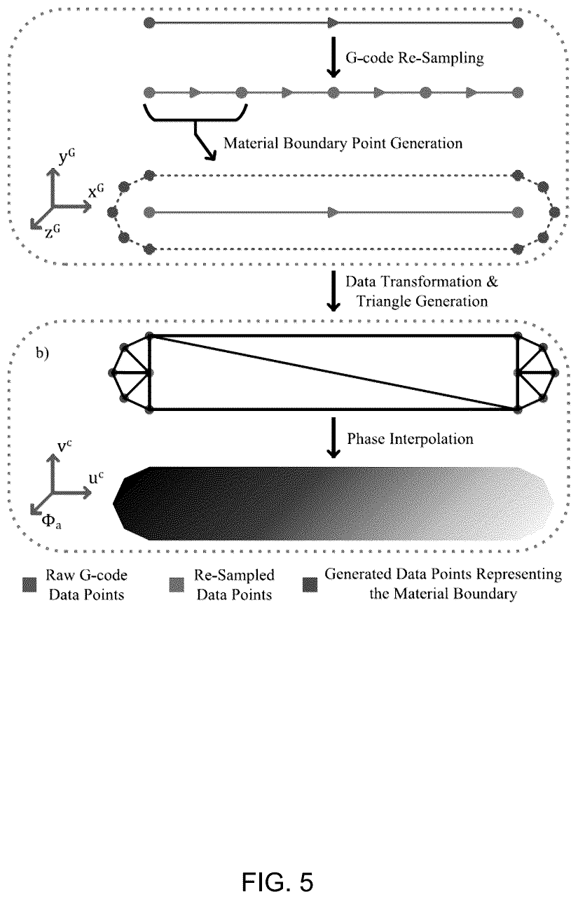

FIG. 5 illustrates a visual example of threshold phase generation. The threshold phase resides in the absolute phase domain and exists as an alternative to specifying a 3D Cartesian z^{g}-threshold for error region detection. Rather than performing error detection by point-wise searching a dense reconstructed 3D point cloud for (x^{g}, y^{g}, z^{g}) data points that fall above or below some z^{g}-threshold, an equivalent z^{g}-threshold may be encoded in the absolute phase domain and used instead for error detection. For each layer of the AM process, a threshold phase map is calculated and pixel-wise compared to its corresponding measured absolute phase map to determine regions of error. With this approach, image processing may be used for error detection, and global 3D reconstruction is avoided. The threshold phase generation procedure from the input G-code data is divided into multiple steps, as summarized in FIG. 5. The input G-code commands are processed to isolate the necessary data points in X^{g} that correspond to material deposition movements. These data points are then re-sampled, postprocessed, linearly transformed, and bilinearly interpolated to obtain a continuous absolute phase map in the camera image coordinate system. Each step of the threshold phase generation procedure is described in more detail below.

### G-Code Re-Sampling

The input 3D model file of the desired print geometry is sliced into G-code commands using the Slic3r opensource software. Raw deposition point position data in X^{g} is extracted from the Slic3r-generated G-code commands and categorized according to layer number. An array containing all of the extracted data is populated as the G-code commands are processed. Any data points that do not correspond to a material deposition movement are not appended to the array. At this stage, the data extracted for each layer number is processed separately, which results in a unique threshold phase map for each layer of the AM process.

The extracted G-code data in Xg exclusively contain the start and end points of the centerline for each material deposition movement of the AM machine that deposits raw material. Each pair of data points in Xg also fully defines the path through which the AM machine must traverse, as shown by the blue points in FIG. 5. Therefore, there are considerable voids in the extracted data, where spatial geometry is, in fact, present at the time of material deposition. The extracted data are re-sampled according to an integer factor greater than one, τ, to reduce the spatial distance between individual data points. An example of re-sampling with τ=4 is shown by the green points in FIG. 5. This re-sampling improves the accuracy of the threshold phase map generation in later steps when the data points in X^{g} are linearly transformed into other coordinate systems.

### Material Boundary Point Generation

Since the re-sampled data points in X^{g} only represent the centerline path of each material deposition movement, additional data points in X^{g} are generated to surround the centerline data points as shown by the red points in FIG. 5. The new data points in X^{g} are spaced from the centerline path according to the radius of the deposited material, rₘ, and approximate the ideal boundary in the x^{g}-y^{g} plane where the material should be deposited with each movement. The number of additional data points in X^{g} required to approximate the boundary of the deposited material depends on the magnitude of rₘ, which is a function of multiple independent parameters, including the diameter of the deposition point of the AM machine, the z-offset setting, and the deposition width setting.

All data points re-sampled and generated in X^{g} are indicated by (x^{g}, y^{g}, z^{g})ₖ, where k is unique to a specific data point. The value of z^{g}ₖ is constant for all k within a single layer and is adjusted from the nominal value specified in the G-code commands to apply the desired error threshold. The value of z^{g}_{k,Q} for the data point k and the layer number Q can be mathematically expressed as

$${𝓏}_{k \cdot Q}^{g} = {H}_{Q} - {ζ}_{Q} ( {H}_{Q} - {H}_{Q - 1} ) \qquad Eq . 13$$

where ζ_{Q} represents the z^{g}-height threshold fraction that defines what multiple of the Qth layer height is the extremum allowable value, and H_{Q} is the nominal total height of the print geometry at the Qth layer. The selection of ζ_{Q} may or may not be layer dependent based on user preference, and its value may be greater than or less than 1. In addition, its value is a function of the user-specified error identification category (over-deposition, under-deposition, missing geometry) and the allowable tolerance range(s) on the manufactured part. Ultimately, ζ_{Q} influences the final threshold phase map for the Qth layer that is used to determine error regions in the manufactured part.

### G-Code Data Mapping

To generate a threshold phase map for each layer of the AM process, (u_{c}, v_{c}, Φₐ) data are required for each (x^{g}, y^{g}, z^{g}) coordinate obtained from the previous step. The necessary data are determined using multiple linear transformations of the (x^{g}, y^{g}, z^{g}) data points. Using Eq. (10), the mapping from (x^{g}, y^{g}, z^{g}) to (x^{p}, y^{p}, z^{p}) can be achieved using the following equation

$${[ {x}^{p} , {y}^{p} , {𝓏}^{p} ]}^{T} = {R}^{MS - 1} [ {[ {x}^{g} , {y}^{g} , {𝓏}^{g} ]}^{T} - {\vec{t}}^{MS} ] \qquad Eq . 14$$

where ⁻¹ denotes the matrix inverse operator. In the system of equations that maps (x^{g}, y^{g}, z^{g})→(u^{c}, v^{c}, Φₐ), there are 12 unknowns: x^{p}, y^{p}, z^{p}, x^{w}, y^{w}, z^{w}, s, u^{p}, v^{p}, u^{c}, v^{c}, and Φₐ. Using Eq. (4), (5), (9), (12), and (14) which yield 12 individual equations, a unique sub-pixel (u^{c}, V^{c}, Φₐ) data point may be calculated for each input (x^{g}, y^{g}, z^{g}) data point as shown by the green and red points in FIG. 5.

### Phase Interpolation

For each layer of the AM process, the threshold phase map is generated one material deposition movement at a time. A triangular partition is performed using the collection of calculated (u^{c}, v^{c}, Φₐ) data points, as shown in FIG. 5. For each triangle, barycentric interpolation is performed between the three relevant (u^{c}, v^{c}) data points. The values for the barycentric weights may be mathematically represented as

$${w}_{υ 1} = \frac{( {υ}_{υ2} - {υ}_{υ3} ) ( {p}_{u} - {υ}_{υ3} ) + ( {υ}_{υ3} - {υ}_{υ2} ) ( {p}_{υ} - {υ}_{υ3} )}{( {υ}_{υ2} - {υ}_{υ3} ) ( {υ}_{υ1} - {υ}_{υ3} ) + ( {υ}_{υ3} - {υ}_{υ2} ) ( {υ}_{υ1} - {υ}_{υ3} )} \qquad Eq . 15$$

$${w}_{υ 2} = \frac{( {υ}_{υ3} - {υ}_{υ1} ) ( {p}_{u} - {υ}_{υ3} ) + ( {υ}_{υ1} - {υ}_{υ3} ) ( {p}_{υ} - {υ}_{υ3} )}{( {υ}_{υ2} - {υ}_{υ3} ) ( {υ}_{υ1} - {υ}_{υ3} ) + ( {υ}_{υ3} - {υ}_{υ2} ) ( {υ}_{υ1} - {υ}_{υ3} )} \qquad Eq . 16$$

$${w}_{υ 3} = 1 - {w}_{υ 1} - {w}_{υ 2} \qquad Eq . 17$$

where wᵥ₁ is the weight corresponding to the first vertex, wᵥ₂ is the weight corresponding to the second vertex, wᵥ₃ is the weight corresponding to the third vertex, uᵥ₁ is the u-coordinate of the first vertex, vᵥ₁ is the v-coordinate of the first vertex, uᵥ₂ is the u-coordinate of the second vertex, vᵥ₂ is the v-coordinate of the second vertex, uᵥ₃ is the u-coordinate of the third vertex, vᵥ₃ is the v-coordinate of the third vertex, pᵤ is the u-coordinate of the current pixel and pᵥ is the v-coordinate of the current pixel. The threshold phase map at each pixel can be mathematically represented as

$${Φ}_{th} ( i , j ) = {Φ}_{a , υ1} {w}_{υ 1 , ( i , j )} + {Φ}_{a , υ2} {w}_{υ 2 , ( i , j )} + {Φ}_{a , υ3} {w}_{υ 3 , ( i , j )} \qquad Eq . 18$$

where Φₜₕ denotes the threshold phase map, Φ_{a,v1} is the absolute phase at the first vertex, w_{v1,(i,j)} is the weight corresponding to the first vertex for the current pixel, Φ_{a,v2} is the absolute phase at the second vertex, w_{v2,(i,j)} is the weight corresponding to the second vertex for the current pixel, Φ_{a,v3} is the absolute phase at the third vertex, w_{v3,(i,j)} is the weight corresponding to the third vertex for the current pixel. The continuous absolute phase from barycentric interpolation applied to a single material deposition movement is locally bounded by rₘ in the u^{c}-v^{c} plane, as shown in FIG. 5.

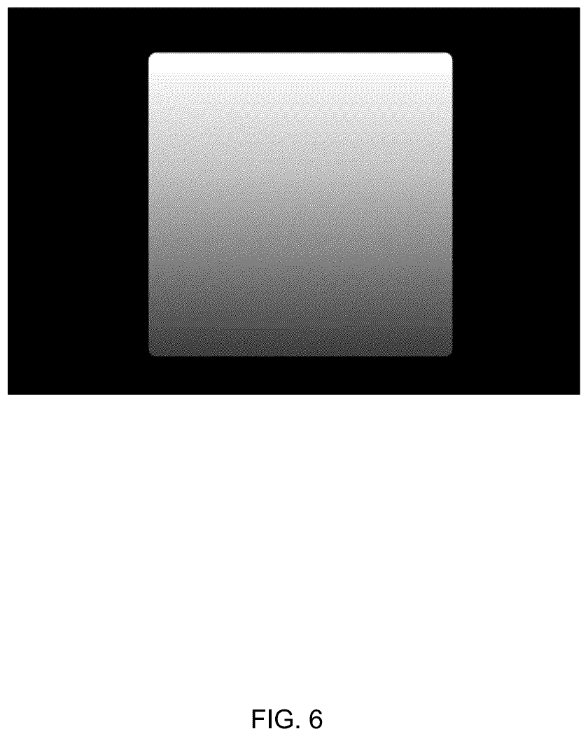

Eq. (18) is only applied to pixels whose values for wᵥ₁, wᵥ₂, and wᵥ₃ fall within [0, 1], since a value for any of the weights outside this range indicates that (pᵤ, pᵥ) is not in the current triangle. A random vertex processing subroutine was created and implemented to determine the minimum number of integer (u^{c}, v^{c}) data points to loop through while performing barycentric interpolation for each triangle. Any remaining vacancies in the generated threshold phase are the result of intended geometric features. The number of triangles necessary to approximate the material boundary edge of each material deposition movement, μ, is a function of rₘ. After barycentric interpolation is performed for all material deposition movements within a specific layer, the result is a continuous threshold phase map that is restricted to the geometric cross section of the print geometry in the camera image coordinate system, as shown in FIG. 6.

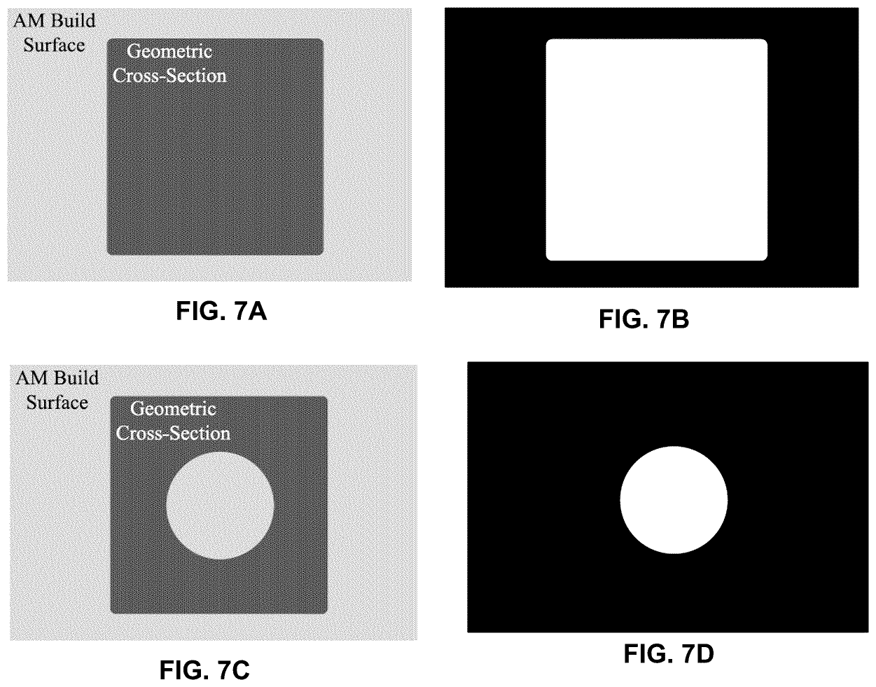

During the threshold phase generation process for each layer, a geometry mask is also generated. This mask is a binary image that describes the geometric extent of the print geometry within the camera image coordinate system. Let h represent the geometry mask image, which is initialized to all zeros and modified according to the following equation:

$$h ( i , j ) = \{ \begin{matrix}1 & {w}_{υ 1 , ( i , j )} ∈ [ 0 , 1 ] ⋀ {w}_{υ 2 , ( i , j )} ∈ [ 0 , 1 ] ⋀ {w}_{υ 3 , ( i , j )} ∈ [ 0 , 1 ] \\ 0 & otherwise\end{matrix} \qquad Eq . 19$$

where Λ represents the AND operator. For each layer of the AM process, a new h is calculated. An example of an ideal geometry raw camera image and its corresponding geometry mask may be seen in FIG. 7A and FIG. 7B, respectively.

### Phase Map Subtraction

With Φth obtained, it can be used along with the measured absolute phase map, Φ_{a,m}, to perform phase map subtraction for the detection of error regions. Let e be a new image that represents the error mask. This mask is a binary image that describes where geometric errors are present within the camera image coordinate system. In the context of under-deposition or missing geometry errors, Φ_{a,m}>Φₜₕ denotes an error. After initializing e to all zeros, the following equation is applied pixel-wise to detect underdeposition or missing geometry errors

$$e ( i , j ) = \{ \begin{matrix}1 & h ( i , j ) = 1 ⋀ ( {Φ}_{a , m} ( i , j ) - {Φ}_{th} ( i , j ) > 0 ) \\ 0 & otherwise\end{matrix} \qquad Eq . 20$$

For each layer of the 3D printing process, new Φ_{a,m}, Φₜₕ, and e are generated. On the contrary, in the context of overdeposition error, Φ_{a,m}<Φₜₕ denotes an error. To detect over-deposition errors parallel to AM build direction, Eq. (20) is applied equivalently, except ‘>’ is switched to ‘<’ in the phase subtraction condition. With the assumption that not all camera pixels corresponding to print geometry are erroneous, the error mask may be considered a sub-mask of the geometry mask. An example of a deposited geometry and its corresponding error mask that denotes missing geometry error may be seen in FIG. 7C and FIG. 7D, respectively.

### 3D Reconstruction of Error Region

If the SL system is calibrated, the error mask can be used alongside the measured absolute phase map and SL system calibration parameters to selectively reconstruct only the erroneous pixels into X^{w} data points. Mathematically, Eq. (11) is only applied to camera image coordinates where e(i, j)=1. After the initial 3D reconstruction, Eq. (9)-(10) are used to map the reconstructed points from X^{w} to X^{g} for further analysis of the 3D data. Once the error region is reconstructed and converted to X^{g}, its topological characteristics can be interpreted by a human or machine to make an informed decision on how to proceed with AM operation. Based on user preference and the particular application, the error region can be objectively or subjectively analyzed to decide whether print termination, error correction, or allowed print continuation is the best solution.

The system 100 may be implemented with additional, different, or fewer components than illustrated. Each component may include additional, different, or fewer components.

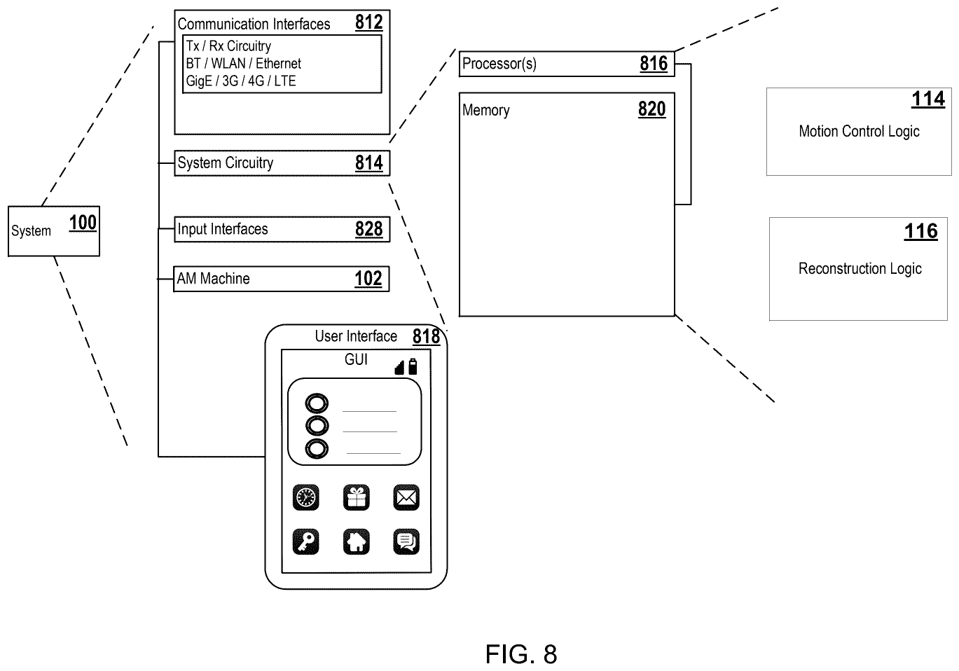

FIG. 8 illustrates a second example of the system 100. The system 100 may include the AM machine 102, or portions thereof, communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations of the motion control logic 114, the reconstruction logic 116, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the motion control logic 114, the reconstruction logic 116, and/or the system 100. Alternatively or in addition, the memory may include any other component or sub-component of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812, system circuitry 814, and or the AM machine 102.

The system 100 may be implemented in many different ways. In some examples, the system 100 may be implemented with one or more logical components. For example, the logical components of the system 100 may be hardware or a combination of hardware and software. The logical components may include the motion control logic 114 and/or the reconstruction logic 116. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a flash drive, a cache, volatile memory, non-volatile memory, RAM, flash memory, or any other type of computer readable storage medium or storage media. The computer readable storage medium may include any type of non-transitory computer readable medium, such as a volatile memory, a non-volatile memory, ROM, RAM, or any other suitable storage device or medium.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A computer-implemented method, comprising:
operating an additive manufacturing machine to deposit a layer of build material onto a build layer or build surface;
projecting, with a structured light projector, a fringe pattern onto the deposited layer;
capturing, with a camera optically aligned with the projector, a set of fringe images of the deposited layer;
computing, by a processor accessing the set of fringe images, a two-dimensional absolute phase map that encodes surface height information of the deposited layer;
generating, by the processor, from build instructions executed by the additive manufacturing machine, a threshold phase map corresponding to an intended geometry of the deposited layer;
comparing, by the processor, the absolute phase map to the threshold phase map on a pixel-by-pixel basis to detect one or more error regions in the deposited layer, wherein the comparison is performed in the two-dimensional phase domain without reconstructing a complete three-dimensional point cloud; and
selectively reconstructing, by the processor, three-dimensional data only for pixels corresponding to the detected one or more error regions, thereby reducing computational resources required for in-situ process monitoring.

2. The method of claim 1, wherein computing the two-dimensional absolute phase map comprises projecting a plurality of phase-shifted fringe patterns and calculating a wrapped phase map that is subsequently unwrapped to yield the absolute phase map.

3. The method of claim 1, wherein comparing the absolute phase map to the threshold phase map comprises performing pixel-by-pixel subtraction to generate a residual phase error map.

4. The method of claim 3, further comprising applying a thresholding operation to the residual phase error map to identify the one or more error regions.

5. The method of claim 1, wherein the one or more error regions correspond to at least one of: insufficiently deposited material, excess deposited material, or geometric distortion of the deposited layer.

6. The method of claim 1, wherein selectively reconstructing three-dimensional data comprises generating a partial point cloud containing only the pixels corresponding to the detected one or more error regions.

7. The method of claim 1, further comprising displaying, on a graphical user interface, a visualization of the detected one or more error regions overlaid on a representation of the deposited layer.

8. The method of claim 7, where in the representation of the deposited layer is generated from a model, g-code, or image of a work piece.

9. The method of claim 1, wherein the processor is further configured to interrupt the additive manufacturing process when the detected error regions exceed a predefined threshold size or number.

10. The method of claim 1, wherein the structured light projector is configured to project sinusoidal fringe patterns of varying spatial frequencies to improve phase unwrapping robustness.

11. A system, comprising:
a camera directed toward a build surface of an additive manufacturing machine;
a projector optically aligned with the camera; and
a processor, the processor configured to:
cause the projector to project a fringe pattern onto a layer of build material deposited by the additive manufacturing machine;
capture, using the camera, a set of fringe images of the deposited layer;
generate, using the fringe images, a two-dimensional absolute phase map that encodes surface height information of the deposited layer;
generate, from build instructions executed by the additive manufacturing machine, a threshold phase map corresponding to an intended geometry of the deposited layer;
comparing, by the processor, the absolute phase map to the threshold phase map on a pixel-by-pixel basis to detect one or more error regions in the deposited layer; and
selectively reconstruct, by the processor, three-dimensional data only for pixels corresponding to the detected one or more error regions, thereby reducing computational resources required for in-situ process monitoring.

12. The system of claim 11, wherein the comparison is performed in the two-dimensional phase domain without reconstructing a complete three-dimensional point cloud.

13. The system of claim 11, wherein to generate the two-dimensional absolute phase map, the processor is further configured to cause the project to project a plurality of phase-shifted fringe patterns and calculate a wrapped phase map that is subsequently unwrapped to yield the absolute phase map.

14. The system of claim 11, wherein to compare the absolute phase to the threshold phase map, the processor is further configured to perform performing pixel-by-pixel subtraction to generate a residual phase error map.

15. The system of claim 11, wherein the one or more error regions correspond to at least one of: insufficiently deposited material, excess deposited material, or geometric distortion of the deposited layer.

16. The system of claim 11, wherein to selectively reconstruct the three-dimensional data, the processor is further configured to generate a partial point cloud containing only the pixels corresponding to the detected one or more error regions.

17. The system of claim 11, where in the processor is further configured to cause a display to show a visualization of the detected one or more error regions overlaid on a representation of the deposited layer.

18. The system of claim 11, where in the representation of the deposited layer is generated from a model or g-code.

19. The system of claim 11, where in the representation of the deposited layer is generated from an image of the deposited layer.

20. The method of claim 1, wherein the processor is further configured to interrupt the additive manufacturing process in response to the detected error regions exceed a predefined threshold size or number.
